(19) United States
(12) Patent Application Publication
(10) Pub. No.: US 2015/0336356 A1
(43) Pub. Date: Nov. 26, 2015

(54) WALL ELEMENT

(71) Applicant: THYSSENKRUPP STEEL EUROPE AG, Duisburg (DE)

(72) Inventors: Anna-Lena POGADETZ-KIEHL, Moers (DE); Peter KLAUKE, Schwerte (DE); Oliver KLEINSCHMIDT, Dortmund (DE); Tobias LEWE, Münster (DE)

(21) Appl. No.: 14/411,446

(22) PCT Filed: Jun. 18, 2013
(86) PCT No.: PCT/EP2013/062632

§ 371 Date: Dec. 26, 2014

(30) Foreign Application Priority Data
Jun. 27, 2012 (DE) 10 2012 105 628.5

(51) Int. Cl. B32B 15/14; E04F 13/08; B32B 15/18; E04B 1/94; B32B 7/12; E04F 13/077; E04F 13/12

(52) U.S. Cl. CPC B32B 15/14; E04F 13/077; E04F 13/0866; E04F 13/12; E04B 1/942; B32B 7/12; B32B 15/18; E04B 2103/06; B32B 2255/06; B32B 2607/00; B32B 2307/306

(57) ABSTRACT

The invention relates to a wall element, in particular for the cladding of building facades, composed of a sandwich-like material composite which is constructed from metallic skin sheets and from at least one core layer arranged between the skin sheets. So that such a wall element is harmless to health, relatively light-weight and stable and has a long useful life and can be produced relatively cost-effectively, according to the invention the core layer is formed from a fibre-containing sealing material resistant to temperatures of up to at least 600° C., the thickness of the core layer amounts to up to 2.0 mm.

The invention relates to a wall element, in particular for the cladding of building facades, composed of a sandwich-like material composite which is constructed from metallic skin sheets and from at least one core layer arranged between the skin sheets.

The use of corrosion-protected or corrosion-resistant metal sheets for the cladding of building facades has been known for a long time. For this purpose, conventionally, large-area metal sheets, which are produced, for example, from hot-galvanized steel strip in the form of trapezoidal, case-type or corrugated profiles, are fastened on mountings for facade claddings and/or directly to the building outside wall. However, standard, that is to say single-layer metal sheets do not offer either satisfactory heat insulation or satisfactory solid-borne soundproofing.

Furthermore, it is known to form metallic wall panels as sandwich panels in order, in particular, to give such panels improved heat insulation properties. For this purpose, a sandwich-like material composite is produced, which is composed of metallic skin sheets and of a core layer of foam. To produce such a material composite, the skin sheets are usually foamed-back.

DE 25 08 353 A1 discloses a low-combustibility composite panel which comprises a sheet-like metal-plastic-metal composite material. The metal layers of this composite material are composed of corrosion-resistant metal sheets or are provided with at least one corrosion-resistant coating. The plastic layer arranged between the metal layers is formed from a plastic which contains inorganic additives in finely distributed form. Furthermore, an adhesive layer is provided, which bonds the plastic to the skin layers, and has high strength at an increased temperature and thereby ensures the transmission of shear forces. The plastic layer is preferably composed of a thermoplastic. This known composite material, which in the building trade is provided for interior completion work and facade claddings, although fulfilling requirements of building material classes B1 to A2 in accordance with DIN 4102, has the disadvantage that it contains ingredients which are hazardous to health according to the GHS Standard. Particularly in closed spaces, in the event of a fire, the situation should be ruled out where persons located or enclosed in these spaces are also exposed to additional influences harmful to health.

Proceeding from this, the object on which the present invention is based is to provide a wall element of the type mentioned in the introduction, which is harmless to health, relatively light-weight and stable and has a long useful life and which can be produced relatively cost-effectively.

To achieve this object, a wall element having the features of Claim 1 is proposed.

The wall element according to the invention is manufactured from a sandwich-like material composite which is constructed from metallic skin sheets and from at least one core layer arranged between the skin sheets. According to the invention, the core layer is in this case formed from a fibre-containing sealing material resistant to temperatures of up to at least 600° C., the thickness of the core layer amounts to up to 2.0 mm.

In addition to temperature resistance, at the same time with good heat insulation, the fibre-containing core layer resistant to temperatures of up to at least 600° C., preferably up to at least 700° C., as compared with the known core layer of plastic, such as the composite panel according to DE 25 08 353 A1 possesses, also contributes to higher rigidity properties of the wall element according to the invention. As a result, the skin sheets of the wall element according to the invention can be made relatively thin, so that, as compared with the known version, a reduction in the weight of the sandwich material or of the wall element produced from it is also possible. Moreover, the wall element according to the invention is also distinguished by good solid-borne soundproofing on account of the fibre-containing temperature-resistant core layer.

The wall element or interior cladding element according to the invention fulfils at least fire protection class A2, sometimes even fire protection class A1, according to DIN 4102, if it especially preferably has a non-combustible fibre-containing core layer.

The thickness of the respective top sheet of the wall element according to the invention lies, for example, in the range of approximately 0.1 mm to 0.8 mm, preferably in the range of approximately 0.1 mm to 0.5 mm, and especially preferably in the range of approximately 0.1 mm to 0.4 mm.

The skin sheets of the wall element according to the invention are preferably manufactured from steel material. Steel material is a relatively cost-effective material which is distinguished by a high temperature resistance, a high breaking strength and good formability, in particular a favourable bending behaviour and/or stamping behaviour.

Non-ferrous metals, such as, for example, aluminum or copper, are also suitable as skin sheets for the wall element according to the invention. Aluminum has the advantage that, in the event of a temperature rise (in the case of a fire) in the ambient atmosphere, a layer of aluminium oxide which is highly temperature-resistant is formed on the free surface.

In order to achieve favourable material costs and at the same time a long useful life of the wall element according to the invention, in a further embodiment of the invention the skin sheets are provided with a corrosion protection layer. The corrosion protection layer is produced, for example, by the hot-dipping and/or electrolytic coating of the metallic skin sheets. Characteristic coatings for hot-dipping are: Z: 99% Zn, ZA: 95% Zn+5% Al; AZ: 5% Al+43.4% Zn+1.6% Si; AS: 88-92% Al+8-12% Si.

A further advantageous embodiment of the wall element according to the invention is characterized in that the skin sheets are of different thickness and/or are provided with different corrosion protection layers. A wall element which is optimal in terms of high bending resistance, low component weight and high weathering resistance can thereby be achieved for the exterior region, for example as a facade element.

In a further embodiment of the wall element according to the invention, at least one of the skin sheets is provided with a corrosion protection layer formed from zinc. Alternatively or additionally, at least one of the skin sheets may also be provided with a corrosion protection layer formed from aluminum.

In addition to the conventional hot-coating and also electrolytic coating, CVD, PVD and/or sol-gel coatings are likewise suitable. Furthermore, the skin sheets may also be finished further, for example by anodizing. There are consequently no limits to colouring.

It is advantageous, in particular, if, according to a further embodiment of the wall element (facade element) according to the invention, at least the outside of the skin sheet which is upper and/or which faces the sun is provided with a corrosion protection layer formed from aluminum. This is because such an aluminum coating gives the wall element (facade element) according to the invention a very low absorption behaviour for solar or thermal radiation or a high heat reflection capacity.

According to a further embodiment of the wall element according to the invention, in exterior or interior applications at least the visible side is additionally provided with an organic coating. Organic coatings in the form of lacquers can have different colours, and therefore there are no limits to the colouring of the wall element according to the invention.

To achieve sufficiently high temperature resistance, the core layer or the sealing material of the core layer of the wall element according to the invention has, in a further embodiment of the invention, a thickness preferably in the range of approximately 0.6 mm to 1.5 mm and especially preferably in the range of approximately 0.7 mm to 1.3 mm.

Furthermore, with a view to a low component weight, it is advantageous if, according to a further embodiment of the invention, the thickness of the core layer amounts to at least 1.5 times, preferably to at least double, especially preferably to at least 2.5 times the thickness of one of the skin sheets or of the thinnest of the skin sheets.

A further advantageous embodiment of the wall element according to the invention is characterized in that the sealing material of the core layer is produced from inorganic fibres, preferably mineral fibres, and from inorganic fillers, preferably mineral fillers, in combination with organic fibres and binders. Tests have shown that such a sealing material makes it possible to have continuous-use temperatures of up to 1000° C.

The sealing material or the core layer of the wall element according to the invention preferably contains a mineral fireproofing agent which is halogen-free and which acts as a smoke-gas suppressant. This is advantageous when the wall element according to the invention is used as interior cladding in closed spaces. Unnecessary additional harm to health can thereby be prevented. Furthermore, the sealing material or the core layer may preferably contain a fungicide which suppresses the formation of mildew in the core layer.

To connect the layers of the sandwich-like material composite, in a further embodiment of the wall element according to the invention the respective skin sheet is bonded to the core layer via an adhesive layer. The adhesive used is in this case preferably an adhesive on an aqueous base, for example a polyurethane dispersion adhesive or heat-sealing adhesive. The layer thickness of the respective adhesive layer in this case lies, for example, in the range of 5 μm to 25 μm, preferably in the range of 8 μm to 15 μm. The adhesive is applied to the skin sheet, for example, by squeegee, spraying-on or coating by means of an applicator roller. The skin layers (skin sheets) and the fibre-containing temperature-resistant sealing material used for the core layer may be connected to one another in strip form or panel form. The connection of the skin layers to the core layer preferably takes place by means of a double belt press. The adhesive (heat-sealing adhesive) applied to the skin sheet is activated in the double belt press by pressure and temperature and is cross-linked with the fibre-containing temperature-resistant core layer.

Alternatively, even while the sealing material or the core layer is being produced, an adhesive on an aqueous base may be introduced, in particular filtered or admixed, into the fibre-containing temperature-resistant sealing material. The step of applying adhesive to the skin sheets can thereby be omitted. As already described above, the connection of the skin layers to the core layer preferably takes place in a double belt press, in which the adhesive is first activated within the core layer by pressure and temperature and cross-linked and simultaneously or subsequently adheres to the skin layers in a materially integral manner.

The sandwich-like material composite according to the invention is formable, in particular bendable and/or stampable, so that any desired configurations from an essentially flat panel up to three-dimensional structures can be produced in different dimensions. In particular, the wall element according to the invention may be designed as a facade element and interior cladding element for buildings and dry construction, in regions where there is a risk of fire and of explosion, such as, for example, in fuel depots and chemical laboratories, and in ship building, and also as a wall element in elevators, in particular elevator cars.

Further preferred and advantageous embodiments of the wall element according to the invention are specified in the subclaims.

The invention is explained in more detail below by means of a drawing which illustrates an exemplary embodiment. The single FIGURE shows two wall elements arranged next to one another in perspective illustration.

The wall elements 1, 1′ illustrated in the drawing serve, for example, as interior cladding elements for buildings, in particular office buildings or public buildings, for example in airports, or for ships.

The respective wall element 1, 1′ is formed from a sandwich-like material composite 2. The material composite 2 is constructed from two metallic skin layers 2.1, 2.2 and from a fibre-containing core layer 2.3 resistant to temperatures of up to at least 600° C.

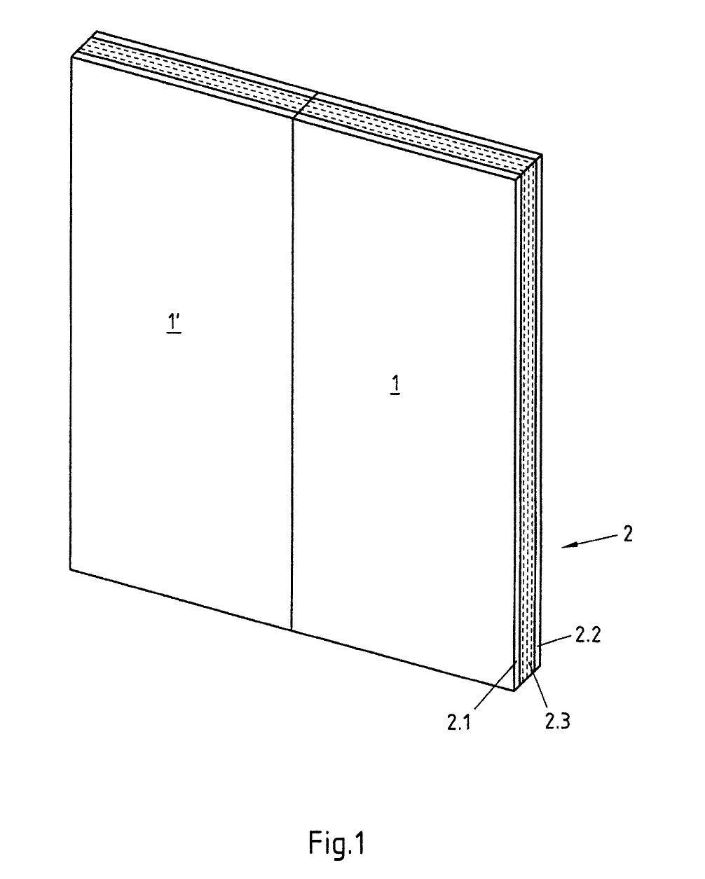

The skin layers 2.1, 2.2 are composed, for example, of sheet steel which is preferably provided with a corrosion protection layer. Corrosion protection layers based on zinc or on aluminum are preferably used in this case. The thickness of the respective skin layer (skin sheet) 2.1, 2.2 amounts, for example, to approximately 0.1 to 0.8 mm, preferably to at most 0.5 mm, especially preferably to at most 0.4 mm. In the exemplary embodiment shown in FIG. 1, the two skin sheets 2.1, 2.2 have essentially the same thickness, for example approximately 0.3 mm, and possess the same material quality. However, skin sheets 2.1, 2.2 of different thickness and/or material quality may also be used to produce the material composite 2. If the wall element according to the invention serves as a facade cladding element, the skin sheets 2.1, 2.2 may be provided with different corrosion protection layers. Thus, for example, the skin sheet 2.1 or 2.2 which faces the sun after the fastening of the respective cladding element may be provided with an aluminum-based coating which possesses a high heat reflection capacity.

The core layer 2.3 is composed of a fibre-containing sealing material which is resistant to temperatures of up to at least 600° C., preferably up to at least 700° C., and has a thickness of approximately 0.5 to 2.0 mm, preferably of approximately 0.6 to 1.5 mm and especially preferably in the range of approximately 0.7 to 1.3 mm.

The material of the core layer 2.3 is composed of a mixture of inorganic fibres, preferably mineral fibres, and of inorganic filler, preferably mineral fillers, with a small fraction of organic fibres and binders. The inorganic fibres, which, together with the inorganic filler, make up the main constituent of the core layer material, are preferably bio-soluble mineral fibres. Moreover, the core layer material may contain a mineral halogen-free fireproofing agent which has a high smoke-gas suppression action. Since the fraction of organic fibres and organic binder in the core layer 2.3 is very small, only a low generation of smoke gas occurs under the action of fire or heat.

The inorganic fibres and mineral fillers of the core layer 2.3 make it possible that such a sealing material layer withstands continuous-use temperatures of up to 900° C. or even up to 1000° C., and preferably is non-combustible. Moreover, the core layer 2.3 formed in this way offers good heat insulation and good soundproofing.

The fibre-containing core layer 2.3 gives the sandwich-like wall element 1, 1′ according to the invention not only high temperature resistance, at the same time with good heat insulation, but also markedly higher rigidity properties, as compared with a core layer of plastic with finely dispersed inorganic additives, such as for example the composite panel according to DE 25 08 353 A1 which is composed of a metal-plastic-metal composite material. These higher rigidity properties allow the use of relatively thin metallic skin layers 2.1, 2.2 and therefore a reduction in the weight of the sandwich-like wall element 1, 1′.

It can be seen clearly in FIG. 1 that each of the skin sheets 2.1, 2.2 of the material composite 2 is designed to be considerably thinner than the core layer 2.3. To achieve a light-weight wall element, the thickness of the core layer 2.3 amounts to at least 1.5 times, preferably to at least double, and especially preferably to at least 2.5 times the thickness of the thinnest of the two skin sheets 2.1, 2.2.

The skin sheets 2.1, 2.2 are connected to the core layer by adhesive bonding. For this purpose, for example, one side of the respective skin sheet 2.1, 2.2 facing the core layer 2.3, is coated with adhesive. The adhesive is preferably an adhesive on an aqueous base, for example polyurethane dispersion adhesive. For a sufficient connection of the skin sheet 2.1, 2.2 and core layer 2.3, the adhesive is applied, for example, with a layer thickness of between 5 and 25 μm, preferably of between 8 and 15 μm, to the skin sheet 2.1, 2.2. The adhesive may be applied, for example, by spraying-on, by squeegee or by means of applicator rollers. The connection of the skin sheets 2.1, 2.2 and core layer 2.3 then preferably takes place by means of a heated double belt press (not shown), in which the adhesive is activated by pressure and temperature and is cross-linked with the fibre-containing temperature-resistant core layer 2.3.

Preferably, the core layer 2.3 is encapsulated in the material composite 2 by the adhesive and/or the skin sheets 2.1, 2.2 against the penetration of moisture.

The composite material 2 according to the invention can easily be formed plastically, in particular by bending and/or stamping. For this purpose, for example, blanks are cut off from an appropriate strip-shaped composite material 2 and are shaped into a wall element 1, 1′ in a forming press (not shown).

The implementation of the invention is not restricted to the exemplary embodiment illustrated in the drawing. On the contrary, numerous variants of the wall element (wall cladding element) 1, 1′ according to the invention may be envisaged, which, even in embodiments deviating from the exemplary embodiment illustrated, make use of the invention specified in the accompanying claims.

1. Wall element, in particular for the cladding of building facades, composed of a sandwich-like material composite which is constructed from metallic skin sheets and from at least one core layer arranged between the skin sheets, characterized in that the core layer is formed from a fibre-containing sealing material resistant to temperatures of up at least 600° C., the thickness of the core layer amounts to up to 2.0 mm.

2. Wall element of claim 1, wherein the thickness of the core layer amounts to at least 1.5 times the thickness of one of the skin sheets or of the thinnest of the skin sheets.

3. Wall element of claim 1, wherein the sealing material of the core layer has a thickness in the range of 0.6 min to 1.5 mm.

4. Wall element of claim 1, wherein the sealing material of the core layer is produced from inorganic fibres, and from inorganic fillers, in combination with organic fibres and binders.

5. Wall element of claim 1, wherein the skin sheets are manufactured from steel material.

6. Wall element of claim 1, wherein the skin sheets are provided with a corrosion protection layer.

7. Wall element of claim 1, wherein the respective skin sheet has a thickness in the range of 0.1 mm to 0.8 mm.

8. Wall element of claim 1, wherein the skin sheets are of different thickness and/or are provided with different corrosion protection layers.

9. Wall element of claim 1, wherein the respective skin sheet is connected to the core layer via an adhesive layer.

10. Wall element of claim 9, wherein the respective adhesive layer is formed from adhesive on an aqueous base, preferably from polyurethane dispersion adhesive.

11. Wall element of claim 9, wherein the respective adhesive layer has a layer thickness in the range of 5 μm to 25 μm.
